(19) United States
(12) Patent Application Publication
(10) Pub. No.: US 2007/0101897 A1
(43) Pub. Date: May 10, 2007

(54) Axle for radial stacker

(76) Inventors: Ronald Stevick, Jackson, MI (US); Roland L. Bunting, Haslett, MI (US)

Correspondence Address: Mary M. Moyne;Fraser Trebilcock Davis & Dunlap, P.C., 124 West Allegan, Suite 1000, Lansing, MI, 48933, US

(21) Appl. No.: 11/593,906

(22) Filed: Nov. 7, 2006

Related U.S. Application Data
(60) Provisional application No. 60/734,239, filed on Nov. 7, 2005.

(51) Int. Cl. B60T 17/22

(52) U.S. Cl. 105/463.1

(57) ABSTRACT

An axle assembly for use with a portable radial stacker which allows a single wheel set on each end of the axle assembly to be used to transport and operate the radial stacker. The wheel sets of the axle assembly can be pivoted and extended so that a width of the axle in the transport mode is less than a width of an axle in the operational mode.

### CROSS-REFERENCE TO RELATED APPLICATIONS

This application claims the benefit of U.S. Provisional Application No. 60/734,239 filed Nov. 7, 2005.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to an axle assembly for use with a portable radial stacker. In particular, the invention relates to an axle assembly having wheel sets which pivot to enable the wheel sets to be used to transport or operate the portable radial stacker.

Radial stackers are well known in the art. Radial stackers or radial stacking conveyors are conveyor systems where the off-load end of the conveyor can be pivoted, radially about a pivot point. Radial stackers are used to stockpile material. The ability of a radial stacker to pivot the off-load end allows the radial stacker to off-load the material in an arcuate path which increases the amount of material which can be stockpiled in a specific area.

Portable radial stackers are also well known in the art. Portable radial stackers have wheels and can be transported from site to site by another vehicle. The wheels of some portable radial stackers can be converted from transport mode to operational mode. When the wheels are in transport mode, the wheels allow the radial stacker to be transported or towed. In operational mode, the wheels are positioned to allow the off-load end of the radial stacker to move radially. To transport a radial stacker using public roads, the radial stacker must meet certain width restrictions. However, during use of the radial stacker, the wheels must be spaced apart to provide sufficient support to prevent the radial stacker from tipping over. As the length of the radial stacker is increased, the spacing between the wheels and thus the width of the radial stacker is increased. For larger radial stackers, such stability cannot be accomplished with wheels which have a spacing which allows transport on public roads. To solve this problem, some portable radial stackers have two (2) sets of wheels. One (1) set allows for transport of the radial stacker. The other set of wheels allows for radially moving the radial stacker. The addition of a second set of wheels necessarily makes the radial stacker more expensive.

(2) Description of the Related Art

The related art has shown various types of portable radial stackers having various types of axle assemblies. Illustrative are U.S. Pat. No. 4,135,614 to Penterman et al.; U.S. Pat. No. 4,427,104 to Reid, Jr.; U.S. Pat. No. 5,515,961 to Murphy et al.; U.S. Pat. No. 5,833,043 to Schmidgall et al.; and U.S. Pat. No. 6,186,311 to Conner.

Penterman et al. describes an axle assembly for use with a portable radial stacker. The axle assembly has a pair of wheel assemblies which includes two wheels. Each wheel assembly may be rotated between the traveling position and the operating position. A motor assembly is affixed to one wheel of at least one wheel assembly to drive the stacker in the operating position about the arc to produce the radial shaped stack of material.

Reid Jr. describes a portable radial stacker having a foldable conveyor and an extendable axle assembly. The axle assembly includes a central horizontal transverse axle member with a swing axle member at each end. Wheels are rotatably mounted on the swing axles. Hydraulic motors are provided to drive the wheels when the stacker is in the operating configuration. A pivotable joint between the central axle member and the swing axle member permits the swing axle member to be pivoted from an operating configuration to a transport configuration. In the operating configuration, the swing axle extends directly in line with the central traverse horizontal axle member providing a wide base to support the radial stacker. In the transport configuration the wheels are located close together behind the central traverse axle member and are oriented for rotation about an axis perpendicular to the length of the conveyor. To move the swing axles from the operating configuration to the travel configuration, each of the ends of the central axle member are lifted in turn and the associated swing axle is swung rearwardly. As each swing axle is rotated rearwardly, the associated wheel remains at essentially the same distance above the ground and the swing axle will rotate from a forwardly tilting orientation to a nearly upright attitude.

Murphy et al. and Schmidgall et al. both describe a portable radial stacker having two sets of wheels. One set is a set of transport wheels and the other set is a set of radial travel wheels. When the radial stacker is being transported the radial travel wheels which are mounted to outriggers are retracted or pivoted upward off the ground. When the radial stacker is in operational mode, the radial travel wheels are extended downward.

Conner describes a self-transporting conveyor system which includes a pair of stacking conveyors and a pair of transfer conveyors. Each of the stacking conveyors has a separate axle and wheel set for road transport and to enable sideways movement of the stacking conveyor. One of the wheels is mounted on a telescoping portion of the axle. When extended, the telescoping wheels provide stability when the stacker is in the operating position. In the retracted position, the telescoping wheels enable the stacker to meet highway width standards. The wheels are supported on the axles by vertical axis pivots or king pins. In one (1) position, the wheel has its axis parallel to the axis of the axle. In the other position, the wheel has its axis nearly perpendicular to the axis of the axle. To move the wheels from the transport mode to the operational mode, the wheels are jacked up and rotated about the king pin and then locked in position and lowered to the ground. The wheels are jacked up and pivoted one at a time. To extend the wheel, the wheel is jacked up off the ground and then the wheel is extended by operation of the hydraulic cylinder, the wheel is then pivoted into operational mode.

Also of some interest is U.S. Pat. No. 3,334,912 to Mauck which describes a vehicle wheel support assembly for trailers and other similar types of vehicles where the sets of wheels of the support assemblies are pivotably mounted to pivot in a generally vertical plane to compensate for unevenness in the road surface. The set of wheels may also be pivotable in a generally horizontal plane to aid in the turning of trailers of excessive lengths.

Only of minimal interest is U.S. Pat. No. 6,591,971 to Sheahan which describes a silage cutter and loader apparatus. The apparatus includes one or more drive wheel assemblies which are able to rotate about a vertical axis, have a range of travel of at least ninety degrees and are able to turn parallel or perpendicular to the longitudinal axis of the apparatus which allows for steering the apparatus.

There remains a need for an axle assembly for a portable radial stacker which has a pair of wheel sets to transport and operate the radial stacker where the wheel sets of the axle assembly can be easily moved from the transport mode to operational mode and where the wheel sets meet the width restrictions in transport mode and provide support for the radial stacker in operational mode.

### BRIEF SUMMARY OF THE INVENTION

An axle assembly for use with a portable radial stacker which allows a single wheel set on each end of the axle assembly to be used to transport and operate the radial stacker. The wheel sets of the axle assembly can be pivoted and extended so that a width of the axle assembly in the transport mode is less than a width of an axle assembly in the operational mode. The wheel sets can be pivoted and extended without the use of a jack or other device to lift the axle assembly. The axle assembly includes an axle frame having pivot brackets at each end with wheel sets pivotably mounted by connector arms to the pivot brackets. The pivot brackets pivot on a vertical axis about the end of the axle frame. The wheel sets are moved from the transport mode with the axis of rotation of the wheel sets essentially perpendicular to the longitudinal axis of the radial stacker and essentially parallel to the longitudinal axis of the axle frame, to the unextended, pivoted position with the axis of rotation of the wheel sets essentially parallel to the longitudinal axis of the radial stacker and essentially perpendicular to the longitudinal axis of the axle frame by pivoting the pivot brackets about the ends of the axle frame. The connector arms pivot on the pivot brackets about a horizontal axis. Pivoting the connector arms on the pivot brackets enables the wheel sets to be moved from the unextended, pivoted position to the extended, operational position.

First piston cylinders can be used between the axle frame and the pivot brackets to pivot the pivot brackets about the vertical axis. In an alternate embodiment, where the wheel sets include a pair of wheels, the wheels of the wheels set have motors which rotate the wheels in opposite directions to rotate the pivot brackets. Second piston cylinders can be used between the first end of the connector arms and the pivot brackets to pivot the wheel sets between the unextended and extended positions. Motors can also be provided on the wheels of the wheel sets to rotate the wheels to move the wheel sets between the unextended and extended positions.

To move the wheel sets from the travel mode to the operational mode, the pivot brackets are pivoted so that the axis of rotation of the wheel sets are essentially parallel to the longitudinal axis of the radial stacker. Next the connector arms are pivoted on the pivot brackets to move the wheel sets away from the axle frame and away from the radial stacker to increase the width of the axle assembly to provide additional support for the radial stacker during operation. During extension of the wheel sets, as the wheel sets move below the pivot point of the pivot brackets and the connector arms, the axle frame and the radial stacker are raised upward slightly and then lowered back down as the wheel sets reach the fully extended position. Once the wheel sets are in the extended position, the pivot brackets can then be rotated back slightly so that the axis of rotation of the wheel sets is not parallel to the longitudinal axis of the radial stacker but is at an angle to the longitudinal axis so that when the wheels rotate, the off-load end of the radial stacker moves in an accurate path about the infeed end of the radial stacker. The pivoting ability of the wheel sets on the pivot brackets can also be used to move the radial stacker in the accurate path during operation. To move the radial stacker, the brake on one wheel set is engaged. Next the wheel set is pivoted from the extended position to the unextended position. However, since the wheel set is unable to rotate, the wheel set does not move, rather the remainder of the radial stacker moves toward the braked wheel set. Thus moving the radial stacker in a direction toward the wheel set. Next the brake for the wheel set is disengaged and the brake for the opposite wheel set is engaged. The unbraked wheel set is then moved into the extended position.

The present invention relates to an axle assembly for use with a radial stacker having opposed ends with a conveyor extending between the ends forming a longitudinal axis of the radial stacker, which comprises an axle frame having opposed ends and configured to be mounted on the radial stacker and a pair of wheel sets pivotably mounted on ends of the axle frame such that each wheel set pivots about one end of the axle frame between a first position with an axis of rotation of the wheel set essentially perpendicular to the longitudinal axis of the radial stacker and a second position with the axis of rotation of the wheel set essentially parallel to the longitudinal axis of the radial stacker and pivots away from and towards the axle frame.

Further, the present invention relates to an axle assembly for use with a radial stacker having opposed ends with a conveyor extending between the ends forming a longitudinal axis of the radial stacker, which comprises an axle frame having opposed ends forming a longitudinal axis of the axle frame and configured to be mounted on the radial stacker, a pair of brackets having a first portion and a second portion and pivotably mounted on each of the ends of the axle frame wherein each bracket is able to pivot between a first position with the second portion of the bracket essentially perpendicular to the longitudinal axis of the axle frame and a second position with the second portion of the bracket essentially parallel to the longitudinal axis of the axle frame, and a pair of wheel sets pivotably mounted on the second portion of each of the brackets wherein each wheel set is able to pivot on the second portion of the bracket between an unextended position with the wheel set adjacent the first portion of the bracket and an extended position with the wheel set spaced apart from the first portion of the bracket.

Still further, the present invention relates to an axle assembly for use with a radial stacker, which comprises an axle frame having opposed ends forming a longitudinal axis of the axle frame and configured to be mounted on the radial stacker, wheel sets, each wheel set having an axis of rotation and movably mounted on the ends of the axle frame, a means for moving the wheel sets from a first position with the axis of rotation of the wheel sets essentially parallel to the longitudinal axis of the axle frame to a second position with the axis of rotation of the wheel sets essentially perpendicular to the longitudinal axis of the axle frame, and means for moving the wheel sets toward or away from the axle frame.

Further still, the present invention relates to a method for moving the wheels of an axle assembly for a radial stacker from a travel mode to an operational mode, the radial stacker having opposed ends forming a longitudinal axis of the radial stacker, the method which comprises the steps of providing the axle assembly including an axle frame having opposed ends with a pair of brackets pivotably mounted on each of the ends of the axle frame, and a pair of wheel sets pivotably mounted on each of the brackets, positioning the pair of wheel sets in the travel mode so that an axis of rotation of each of the wheel sets is essentially perpendicular to the longitudinal axis of the radial stacker, pivoting the brackets such that the axis of rotation of each of the wheel sets is essentially parallel to the longitudinal axis of the radial stacker, and pivoting each of the wheel sets on the brackets such that wheels of each of the wheel sets rotate about the axis of rotation of the wheel sets and the wheel sets are moved from an unextended position adjacent the axle frame outward away from the axle frame to an extended position.

Further still, the present invention relates to a method for operating a radial stacker having opposed first and second ends forming a longitudinal axis of the radial stacker which comprises the steps of providing an axle assembly mounted on the radial stacker having an axle frame with opposed first and second ends with first and second wheel sets pivotably mounted on the first and second ends of the axle frame respectfully so that the wheels sets are able to pivot toward and away from the axle frame, positioning the wheel sets in a fully extended position away from the axle frame, engaging a brake of the first wheel set, pivoting the first wheel set such that the first wheel set is moved from the extended position to an unextended position wherein the brake prevents the first wheel set from moving which moves the radial stacker toward the first wheel set to move the first wheel set from the extended position to the unextended position, disengaging the brake of the first wheel set, engaging the brake of the second wheel set, and pivoting the first wheel set so that the first wheel set moves from the unextended position to the extended position.

The substance and advantages of the present invention will become increasingly apparent by reference to the following drawings and the description.

### BRIEF DESCRIPTION OF THE DRAWINGS

FIG. 1 is a perspective view of the portable radial stacker 100 with the wheel sets 34 in the transport mode.

FIG. 2 is a view of the axle assembly 10 with a partial exploded view of the first wheel assembly 20.

FIG. 3 is a perspective view of the axle assembly 10 with the wheel assemblies 20 and 50 in the transport mode.

FIG. 4 is a partial perspective view of the portable radial stacker 100 showing the second wheel assembly 50 in the partially, pivoted position.

FIG. 5 is a front perspective view of the axle assembly 10 with the first wheel assembly 20 in the transport mode and second wheel assembly 50 in the partially, pivoted position.

FIG. 6 is a front perspective view of the axle assembly 10 with the first and second wheel assemblies 20 and 50 in the pivoted, unextended position.

FIG. 7 is a partial front perspective view of the portable radial stacker 100 with the second wheel assembly 50 in the pivoted, unextended position.

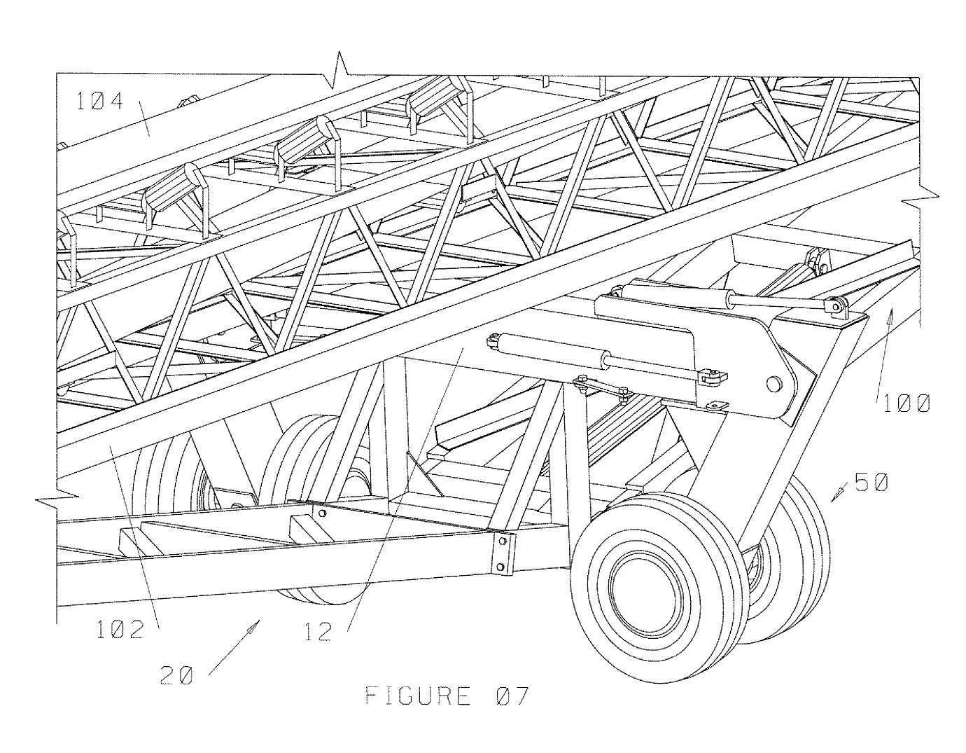

FIG. 8 is a front perspective view of the axle assembly 10 with the first wheel assembly 20 in the pivoted, unextended position and the second wheel assembly 50 in the pivoted, partially extended position.

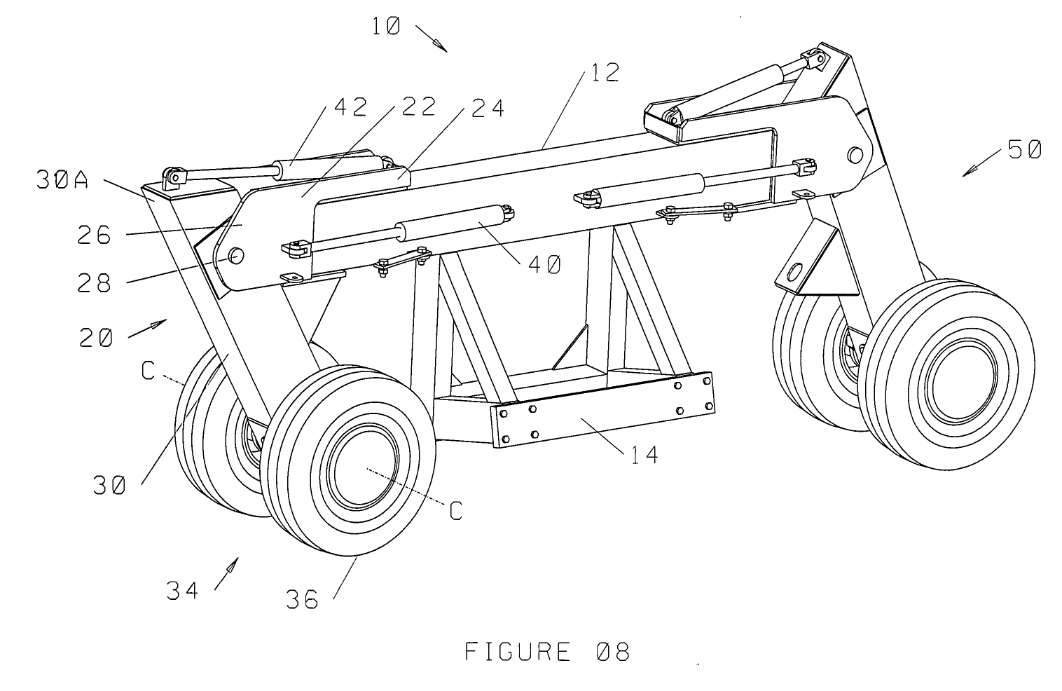

FIG. 9 is a partial front perspective view of the axle assembly showing the second wheel assembly 50 in the pivoted, extended position.

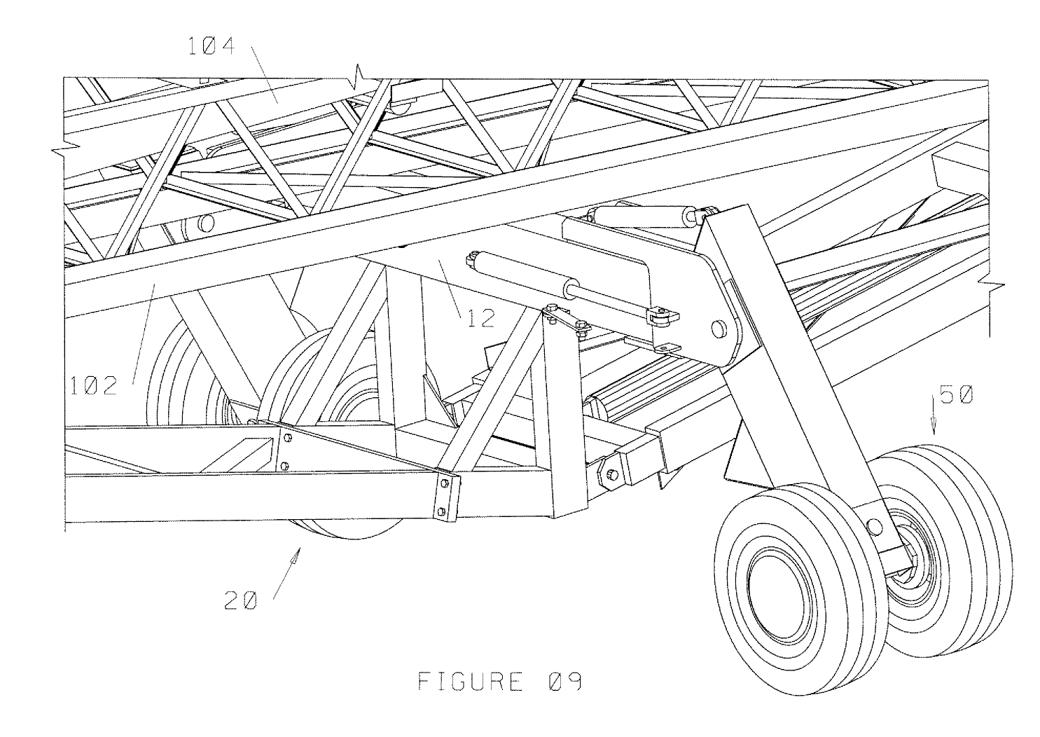

FIG. 10 is a partial front view of the axle assembly 10 with the first and second wheel assemblies 20 and 50 in the pivoted, operational mode.

FIG. 11 is a perspective view of the axle assembly 10 with the first and second wheel assemblies 20 and 50 in the pivoted, extended operational mode.

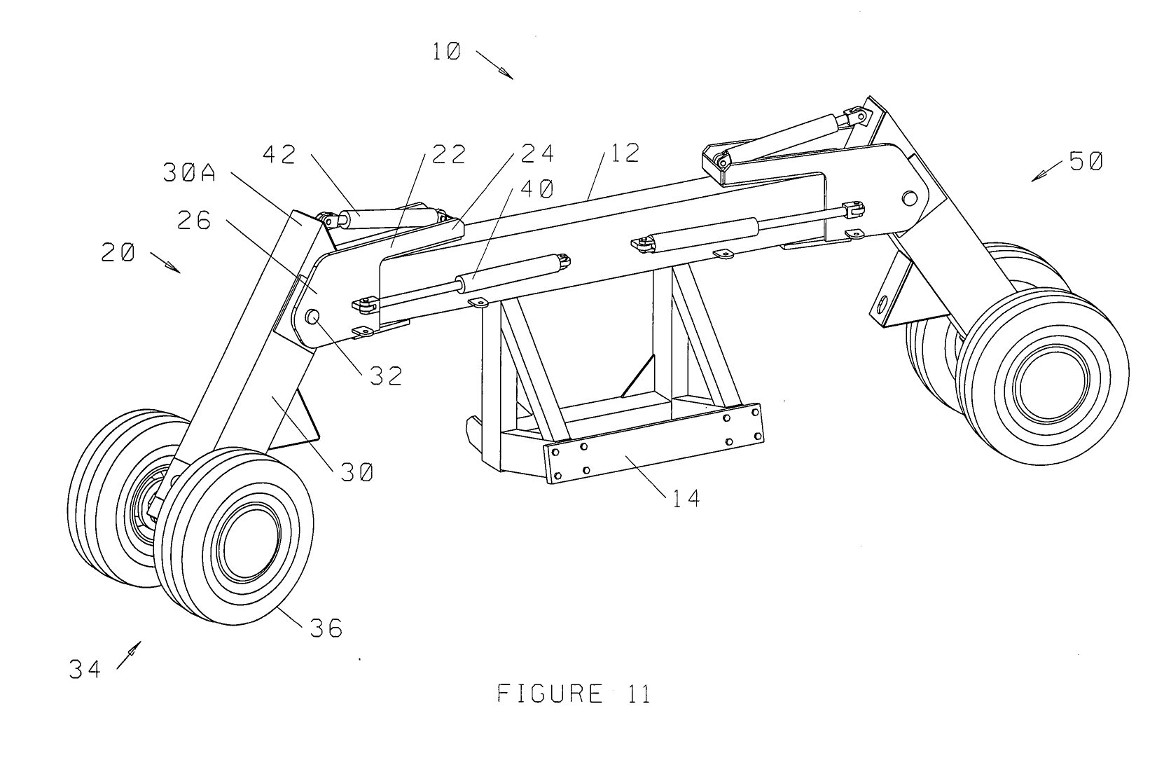

FIG. 12 is an exploded view of the first wheel set 34 showing the wheels 36, the motor 44 and brake 46.

### DETAILED DESCRIPTION OF THE INVENTION

All patents, patent applications; government publications, government regulations, and literature references cited in this specification are hereby incorporated herein by reference in their entirety. In case of conflict, the present description, including definitions, will control.

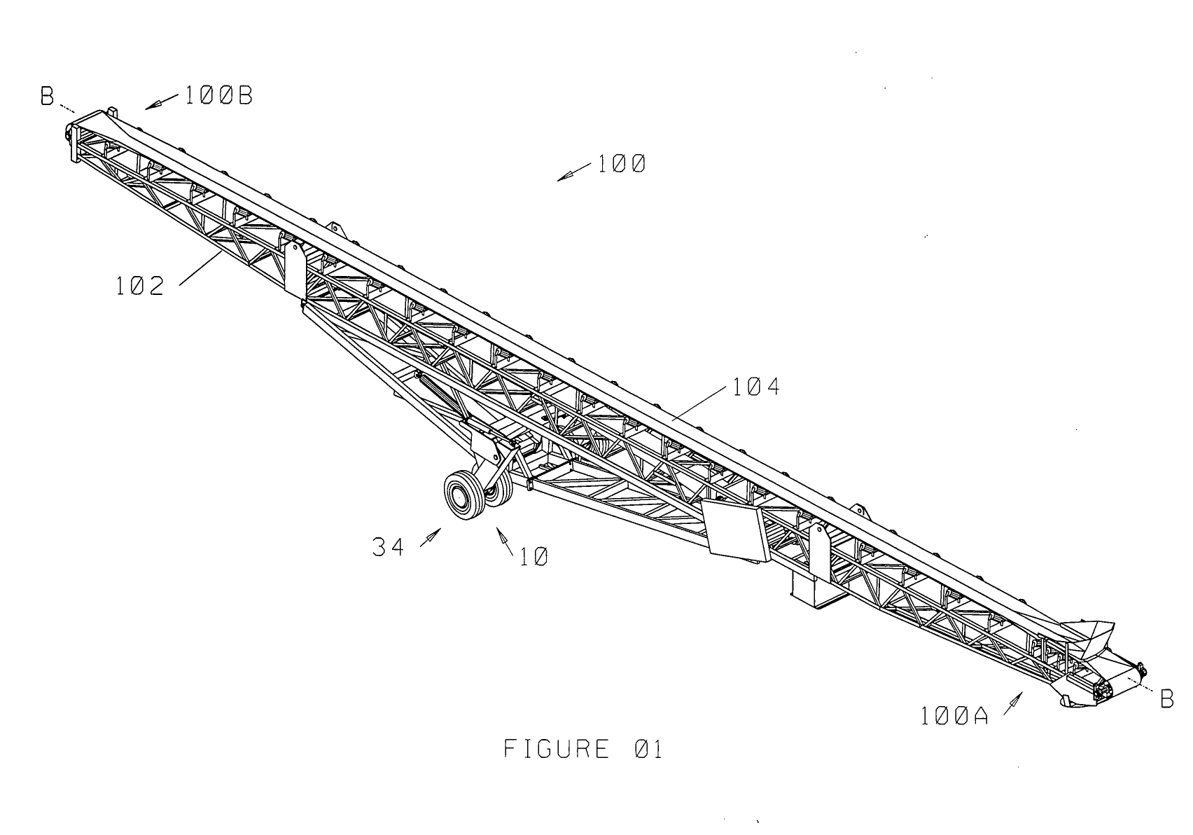

The present invention relates to an axle assembly 10 for use with a portable radial stacker 100. In general, radial stackers or radial stacking conveyors 100 include a frame 102 with an endless conveyor belt 104 mounted over drive rollers and follower rollers along a top of the frame 102. The radial stacker 100 includes an infeed end 100A and an off-load end 100B with the conveyor belt 104 extending therebetween. The ends 100A and 100B of the radial stacker 100 form the longitudinal axis B-B of the radial stacker 100 (FIG. 1). During transport, the frame 102 of the radial stacker 100 at the infeed end 100A is connected to a towing vehicle (not shown). During operation, the infeed end 100A of the radial stacker 100 is adjacent the ground surface and the off-load end 100B is spaced above the ground surface. The radial stacker 100 pivots in an arc about the infeed end 100A to stockpile the material in an arcuate stack. In one (1) embodiment, the frame 102 is telescoping such that the length of the radial stacker 100 can be extended during operation. The length of the radial stacker 100 is reduced to allow for transport. In one (1) embodiment, the frame 102 of the radial stacker 100 adjacent the off-load end 100B pivots so that the length of the radial stacker 100 can be shortened by pivoting the off-load end 100B approximately 180° so that the off-load end 100B is adjacent a center portion of the radial stacker 100. Various types of portable radial stackers 100 are well known in the art and include telescoping and foldable radial stackers such as described in U.S. Pat. No. 4,427,104 to Reid, Jr.; U.S. Pat. No. 6,056,252 to Johannsen; and U.S. Pat. No. 6,360,876 to Nohl et al. which are incorporated herein by reference in their entirety.

The axle assembly 10 is mounted to the bottom of the frame 102 of the radial stacker 100 on a side opposite the conveyor belt 104. The axle assembly 10 allows for transporting the radial stacker 100 and allows for moving the radial stacker 100 in an arcuate path during operation. The axle assembly 10 of the present invention may be retrofitted onto existing radial stackers 100 or it may be included on newly manufactured radial stackers 100. The axle assembly 10 is mounted closer to the off-load end 100B of the radial stacker 100 than the infeed end 100A of the radial stacker 100. In one (1) embodiment, the axle assembly 10 is positioned so that approximately 55% of the radial stacker 100 extends between the infeed end 100A and the axle assembly 10.

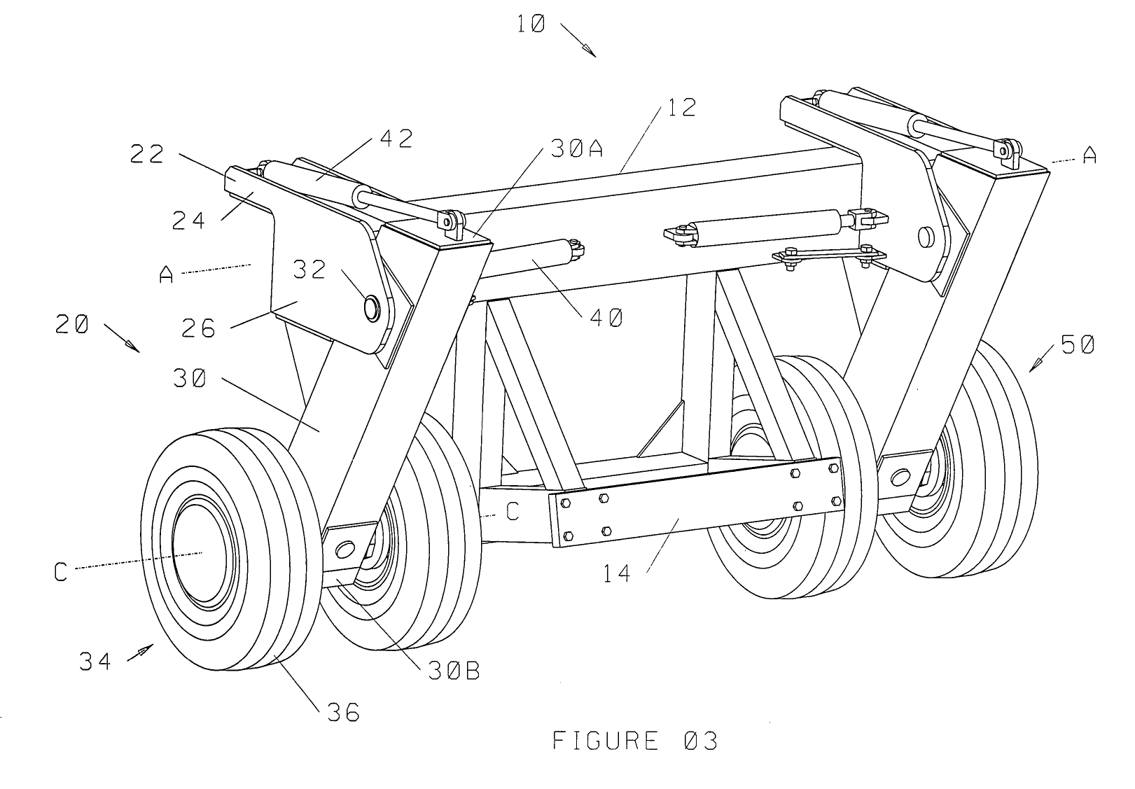

The axle assembly 10 can be connected to the frame 102 of the radial stacker 100 using a variety of methods and structures. In one (1) embodiment, the axle assembly 10 is mounted to the frame 102 using an axle frame 12 and a lower frame 14. The axle frame 12 of the axle assembly 10 is mounted to the frame 102 of the radial stacker 100. The axle frame 12 has opposed first and second ends 12A and 12B forming the longitudinal axis A-A of the axle frame 12 (FIG. 3). The axle frame 12 has a length such that when the axle assembly 10 is mounted on the frame 102 of the radial stacker 100, the ends 12A and 12B of the axle frame 12 extend beyond the sides of the frame 102 of the radial stacker 100. In one (1) embodiment, the axle frame 12 extends perpendicular to the conveyor belt 104 of the radial stacker 100. In one (1) embodiment, the lower frame 14 of the axle assembly 10 extends essentially parallel to the axle frame 12 and is connected to the axle frame 12 by vertical connectors that extend essentially perpendicular to the axle frame 12 and the lower frame 14. In one (1) embodiment, the lower frame 14 is shorter in length than the axle frame 12 such that the lower frame 14 does not interfere with the wheel assemblies 20 and 50 when the wheel assemblies 20 and 50 are rotated from the transport position to the initial, pivoted, unextended position. The frame 102 of the radial stacker 100 is attached to the lower frame 14 of the axle assembly 10 by struts. The struts extend outward from the lower frame 14 at an angle and are connected to the underside of the frame 102 of the radial stacker 100 opposite the conveyor belt 104. The struts enable the axle assembly 10 to rotate the radial stacker 100 by moving the rotating force outward away from the axle assembly 10 and the wheels 36 and toward the ends 100A and 100B of the radial stacker 100.

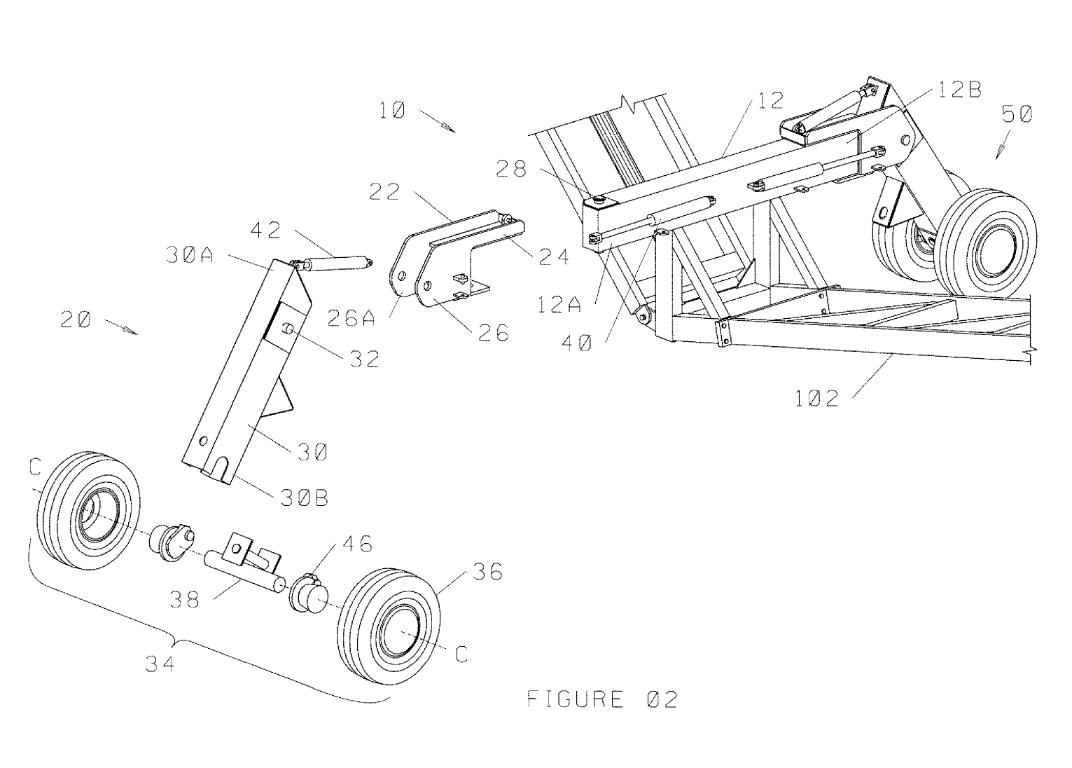

The axle assembly 10 includes first and second wheel assemblies 20 and 50 which are pivotably mounted on each end 12A and 12B of the axle frame 12. The wheel assemblies 20 and 50 are identical and therefore, only the first wheel assembly 20 will be discussed in detail. The first wheel assembly 20 includes a pivot bracket 22, a connector arm 30 and a first wheel set 34 (FIG. 2). The pivot bracket 22 is pivotably mounted on the first end 12A of the axle frame 12 and includes a first portion 24 and a second portion 26. The first portion 24 of the pivot bracket 22 is pivotably mounted on the axle frame 12. To mount the pivot bracket 22 on the axle frame 12, a first pivot pin 28 is inserted through a hole in the first portion 24 and through a hole in the first end 12A of the axle frame 12 to pivotably mount the pivot bracket 22 to the axle frame 12. The first pivot pin 28 extends essentially vertical to the ground surface which allows the pivot bracket 22 to rotate about a vertical axis in a plane essentially horizontal to the ground surface. In one (1) embodiment, a spacer (not shown) is positioned between the first portion 24 of the pivot bracket 22 and the axle frame 12 to space the pivot bracket 22 away from the axle frame 12 to reduce friction during pivoting of the pivot bracket 22. In one (1) embodiment, the spacer is constructed of a lower friction material such as Teflon®. The second portion 26 of the pivot bracket 22 extends outward from the first portion 24 in a direction opposite and below the first portion 24. The second portion 26 has a pair of spaced apart legs 26A which extend outward essentially parallel to the first portion 24. When the first portion 24 is aligned with the axle frame 12, the legs 26A of the second portion 26 extend outward essentially parallel to the axis A-A of the axle frame 12. The first and second portions 24 and 26 of the pivot bracket 22 are positioned with respect to each other such that when the pivot bracket 22 pivots on the axle frame 12, the second portion 26 is spaced beyond the end 12A of the axle frame 12 and does not contact the axle frame 12.

The connector arm 30 has a first end 30A and a second end 30B and is pivotably mounted between the legs 26A of the second portion 26 of the pivot bracket 22. To mount the connector arm 30 to the pivot bracket 22, a second pivot pin 32 is inserted through the first leg 26A of the second portion 26 of the pivot bracket 22, through the connector arm 30 and through the second leg 26A of the second portion 26 of the pivot bracket 22. In one (1) embodiment, the pivot pin 32 is constructed as part of the connector arm 30 and extends outward from each side of the connect arm 30. The connector arm 30 is pivotably mounted to the pivot bracket 22 adjacent to the first end 30A of the connector arm 30. In one (1) embodiment, when the connector arm 30 is positioned between the legs 26A of the second portion 26 of the pivot bracket 22, the first end 30A of the connector arm 30 extends upward beyond the legs 26A of the second portion 26 of the pivot bracket 22 and the second end 30B of the connector arm 30 extends downward below the legs 26A. In one (1) embodiment, the first end 30A of the connector arm 30 extends beyond the first portion 24 of the pivot bracket 22 and the axle frame 12.

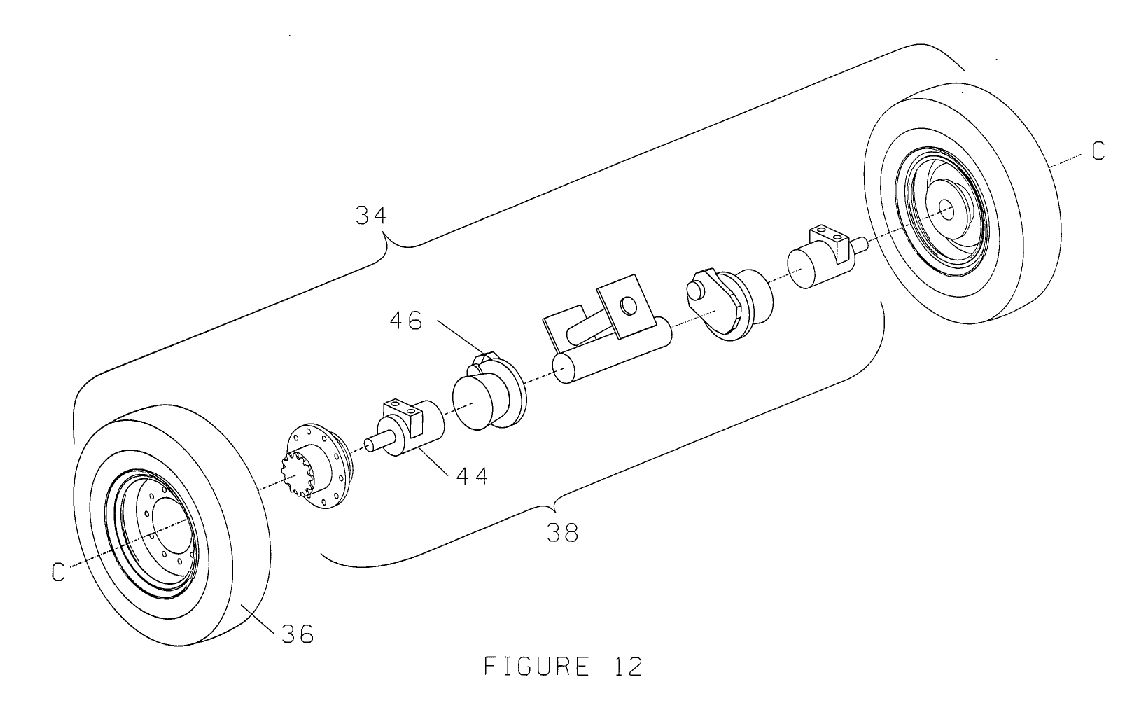

The second end 30B of the connector arm 30 is connected to the first wheel set 34. In one (1) embodiment, the first wheel set 34 includes a pair of wheels 36 connected together by an axle 38. However, it is understood that the first wheel set 34 could include a single wheel or a plurality of wheels connected together by one (1) or more axles 38. The wheels 36 can be similar to wheels well known in the art. In one (1) embodiment, the wheels 36 are rotatably mounted on the axle 38 and the axle 38 is fixably mounted on the second end 30B of the connector arm 30. In another embodiment, the wheels 36 are fixably mounted on the axle 38 and the axle 38 is rotatably mounted to the second end 30B of the connector arm 30. The axle 38 can be mounted to the connector arm 30 by any well known means. In one (1) embodiment, the axle 38 has opposed ends and includes a gear drive at each end. The gear drive allows for securing the wheels 36 onto the axle 38. In one (1) embodiment, one (1) of the wheels 36 of the first wheel set 34 has a motor 44 for moving the wheel 36. In one (1) embodiment, both of the wheels 36 of each of the wheel sets 34 are provided with a motor 44 to allow the axle assembly 10 to have four wheel drive. In one (1) embodiment, each wheel 36 of the wheel sets 34 of the radial stacker 100 is equipped with a brake 46 (FIG. 12.) In one (1) embodiment, the brake 46 is a hydraulic brake. In another embodiment, the brake is an air brake.

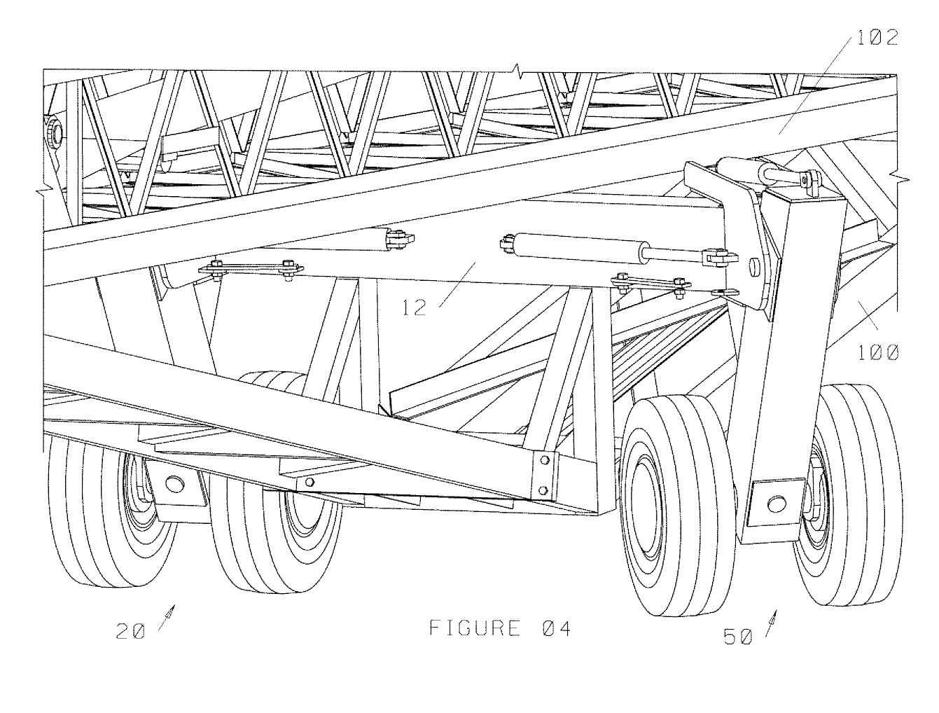

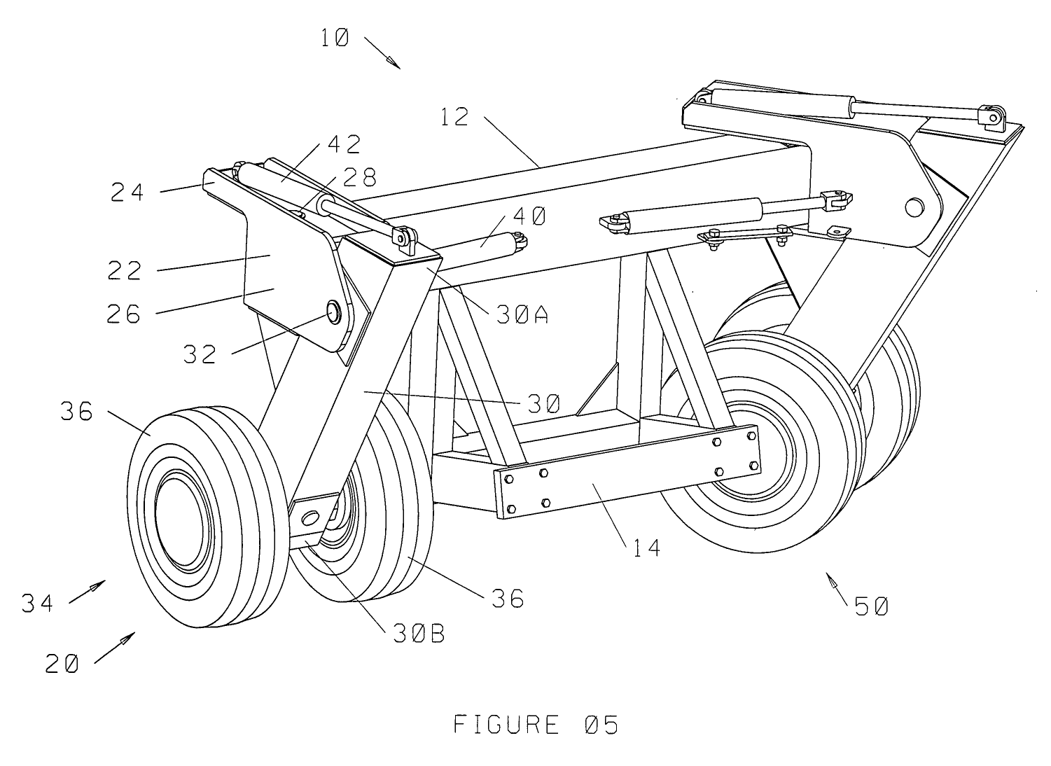

In one (1) embodiment, the first wheel assembly 20 is provided with a first piston cylinder 40 for pivoting the pivot bracket 22 of the wheel assembly 20 on the axle frame 12 about the first pivot pin 28 to change the orientation of the first wheel set 34 from the transport position or transport mode to the radial movement position or operational mode (FIGS. 4 to 6). The first piston cylinder 40 is mounted between the axle frame 12 and the second portion 26 of the pivot bracket 22 (FIG. 2). In one (1) embodiment, the first piston cylinder 40 is a hydraulic piston. In another embodiment where the first wheel set 34 has at least two (2) wheels 36, the pivot bracket 22 is pivoted by rotation of the wheels 36 of the wheel set 34. In this embodiment, motors 44 are connected to each of the wheels 36 of the first wheel set 34 (FIG. 12). The motors 44 rotate the wheels 36 in different directions which pivots the pivot bracket 22 on the axle frame 12. In one (1) embodiment, the motors 44 are hydraulic motors. In one (1) embodiment, each wheel 36 has a separate motor 44. It is understood that a variety of mechanisms well known in the art such as a linear motor or screw drive can be used to pivot the pivot bracket 22 and the first wheel set 34 about the first pivot pin 28.

In one (1) embodiment, the wheel assembly 20 includes a second piston cylinder 42 for pivoting the first end 30A of the connector arm 30 on the second pivot pin 32 toward and away from the axle frame 12 to move the first wheel set 34 on the second end 30B of the connector arm 30 away from and toward the axle frame 12 and the frame 102 of the radial stacker 100. The second piston cylinder 42 is connected at one (1) end to the first portion 24 of the pivot bracket 22 and at the other end to the first end 30A of the connector arm 30 (FIG. 3). In one (1) embodiment, the second piston cylinder 42 is a hydraulic piston. In another embodiment, where the first wheel set 34 has motors 44, rotation of the wheels 36 of the wheel set 34 can be used to move the wheel set 34 from the unextended to the extended position. It is understood that any type of mechanism such as a screw drive or a linear motor well known in the art could be used to pivot the connector arm 30 to move the first wheel set 34 away from and toward the frame 102 of the radial stacker 100.

In one (1) embodiment, where the wheels 36 of the wheel set 34 have motors 44, the motor 44 is used to rotate the first wheel set 34 to position the radial stacker 100 and to rotate the off-load end 100B of the radial stacker 100 in an arcuate path during operation. Any type of motor well known in the art can be used to rotate the wheels 36. In one (1) embodiment, the motors used to pivot the first wheel set 34 and the motor 44 used to rotate the wheels 36 of the first wheel set 34 is the same motor 44.

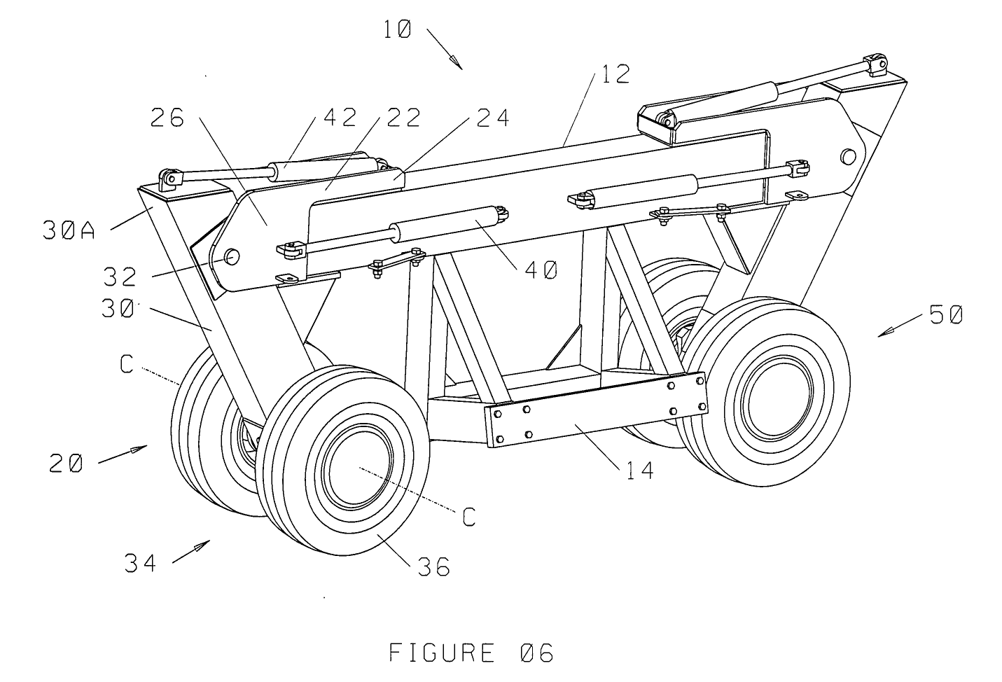

To transport the radial stacker 100, the wheel sets 34 are positioned in the initial unpivoted, unextended transport mode (FIGS. 1 and 3). Since the first and second wheel assemblies 20 and 50 are similarly positioned, only the positioning of the first axle assembly 20 will be described in detail. In one embodiment, the position with the wheel assemblies 20 and 50 are changed simultaneously. In one (1) embodiment, in the initial unpivoted, unextended transport mode, the second portion 26 of the pivot bracket 22 is perpendicular to the longitudinal axis A-A of the axle frame 12 and the second portion 26 of the pivot bracket 22 extends outward from the axle frame 12 toward the infeed end 100A or towing end of the radial stacker 100. In this position, the axis of rotation C-C of the wheels 36 is essentially aligned with the longitudinal axis A-A of the axle frame 12 and is essentially perpendicular to the longitudinal axis B-B of the radial stacker 100. In one (1) embodiment, in the transport mode, the wheel sets 34 extend partially below the axle frame 12. In one (1) embodiment, the side of the support arm 30 adjacent the axle frame 12 has a brace. When the wheel set 34 is in the unextended position, the axle frame 12 contacts and rests on the brace which transfers the load of the radial stacker 100 from the axle frame 12 to the support arm 30 and the wheel set 34 and away from the second pivot pin 32. In the transport mode, the total width of the axle assembly 10 is such that the radial stacker 100 can be transported on public roads. In one (1) embodiment, the total width of the axle assembly 10 is the transport mode is less than 12 feet (3667 mm). To transport the radial stacker 100, the front end or infeed end 100A is connected to a towing vehicle such as a fifth wheel vehicle. When the radial stacker 100 is being transported, the wheels 36 of the first wheel set 34 are able to rotate fully. To operate the radial stacker 100 to move or stockpile material, the off-load end 100B of the radial stacker 100 is positioned adjacent the stacking area and the infeed end 100A is positioned adjacent the material to be moved. In one (1) embodiment, the motors 44 on the wheels 36 are used when the first wheel set 34 is in the initial unpivoted, unextended transport position to adjust or fine tune the position of the radial stacker 100. Once the radial stacker 100 is correctly positioned, the wheel sets 34 are rotated into the unextended, pivoted position or pivoted mode (FIG. 6).

To move the first wheel set 34 to the unextended, pivoted position, the pivot bracket 22 is rotated on the first pivot pin 28. In one (1) embodiment, the pivot bracket 22 is moved so that the legs 26A of the second portion 26 of the pivot bracket 22 are essentially aligned with the longitudinal axis A-A of the axle frame 12 and the axis of rotation C-C of the wheels 36 is perpendicular to the longitudinal axis A-A of the axle frame 12 and essentially parallel to the longitudinal axis B-B of the radial stacker 100. In this position, the wheels 36 are located partially below the axle frame 12 and partially below the pivot bracket 22 (FIG. 6). However, the pivot bracket 22 can be pivoted such that the legs 26A of the second portion 26 of the pivot bracket 22 are at an angle to the longitudinal axis A-A of the axle frame 12. In one (1) embodiment, the first piston cylinder 40 is extended to pivot the pivot bracket 22. In another embodiment, where motors 44 are connected to each of the wheels 36, to change the orientation of the first wheel set 34, the wheels 36 of the first wheel set 34 are rotated in different directions as necessary to move the wheel assembly 20 on the first pivot pin 28. In one (1) embodiment, as the pivot bracket 22 and first wheel set 34 are pivoted, the wheels 36 rotate freely to make movement easier. In one (1) embodiment, the wheels 36 slide along the ground surface during pivoting of the pivot bracket 22 and the first wheel set 34. Once in the correct position, the pivot bracket 22 is locked in place.

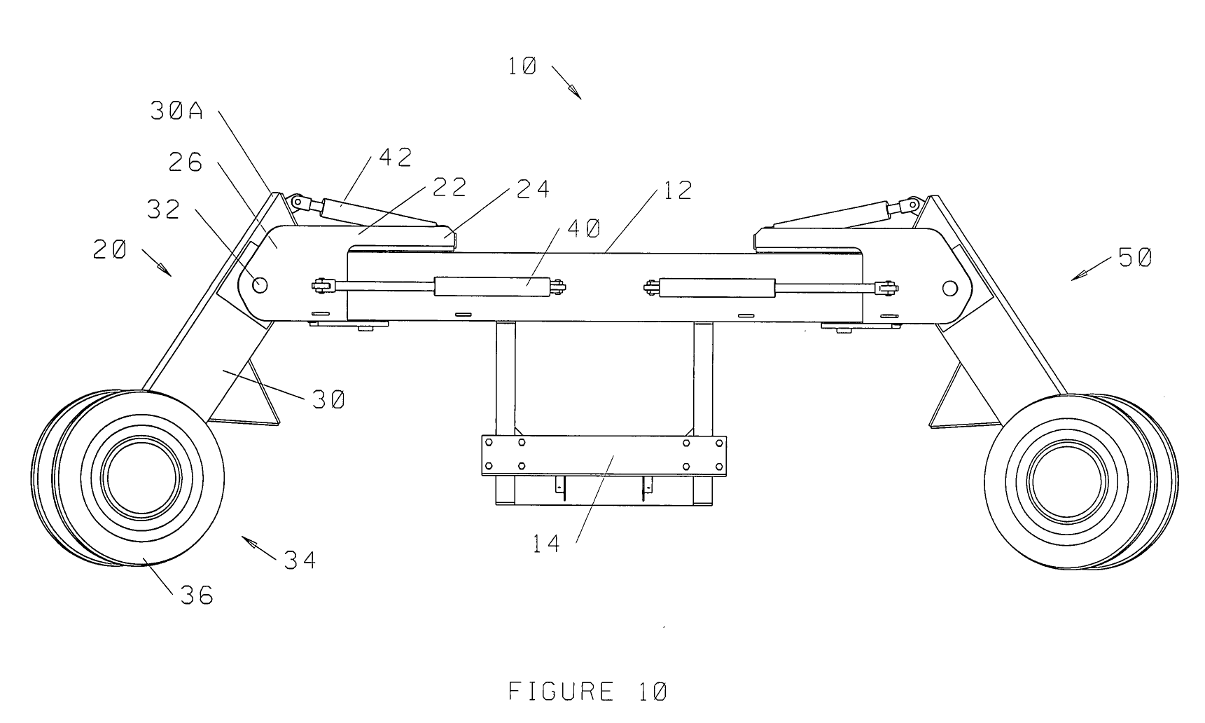

Next, the wheel assemblies 20 and 50 are pivoted into the extended position or operational mode (FIG. 10). The connector arm 30 is pivoted about the second pivot pin 32 to move the first wheel set 34 away from the frame 102 of the radial stacker 100. In one (1) embodiment, the second piston cylinder 42 is retracted to pull the first end 30A of the connector arm 30 toward the first portion 24 of the pivot bracket 22 and to move the wheel set 34 on the second end 30B of the connector arm 30 away from the first portion 24 of the pivot bracket 24. In another embodiment, the motors 44 are used to rotate the wheels 36 of the wheel set 34 to move the wheel set 34 between the unextended and extended position. As the first wheel set 34 moves from the initial, unextended position with the axis of rotation C-C of the wheels 36 essentially perpendicular to the longitudinal axis A-A of the axle frame 12, the length of the connector arm 30 from the pivot point to the wheel set 34 and the diameter of the wheels 36 may cause the radial stacker 100 to be raised slightly away from the ground surface as the wheel set 34 moves directly underneath the second pivot pin 32 and the connector arm 30 is perpendicular to the longitudinal axis A-A of the axle frame 12. As the first wheel set 34 continues to move toward the extended position, the radial stacker 100 lowers to the “at rest” position. The positioning of the pivot bracket 24 such that the axis of rotation C-C of the wheels 36 is essentially perpendicular to the longitudinal axis A-A of the axle frame 12, enables the wheels 36 to easily rotate during movement of the first wheel set 34 to the extended position. In the embodiment where the pivot bracket 24 is pivoted to so that the axis of rotation C-C is at an angle not perpendicular to the axis A-A of the axle frame 12, the amount of force needed to move the first wheel set 34 to the extended position is greater since the wheels 36 create friction with the ground surface. When the first wheel set 34 is in the extended position, the first wheel set 34 is spaced apart from the frame 102 of the radial stacker 100 and provides additional support or stabilization to the radial stacker 100 as outriggers (FIG. 10). The spacing between the wheel sets 34 during radial movement must be sufficient to prevent the radial stacker 100 from tipping laterally when it is in its fully extended position in length and height. In one (1) embodiment, the connector arm 30 is of such a length that when the wheel sets 34 are in the fully extended, operational position, the wheel sets 34 are spaced apart from the ends 12A and 12B of the axle frame 12 approximately 3 ft. (914 mm). Once the wheel sets 34 are in the fully, extended position, the wheel sets 34 are rotated back slightly about the first pivot pin 28 so that the axis of rotation C-C of the wheels 36 is no longer perpendicular to the axis A-A of the axle frame 12 (FIG. 10). Pivoting the wheel sets 34 backwards enables the radial stacker 100 to move in an arcuate path about the infeed end 100A of the radial stacker 100. In one (1) embodiment, the wheel sets 34 are moved backwards between about 5 and 10 degrees. However, it is understood that the amount the wheels sets 34 are pivoted back depends on the position of the axle assembly 10 between the ends 100A and 100B of the radial stacker 100. The shorter the distance between the axle assembly 10 and the off-load end 100B of the radial stacker 100, the smaller the pivot back angle.

To use the radial stacker 100 to move and stack material along an arcuate or radial path once the radial stacker 100 is in the operational mode with the wheel sets 34 in the extended, operational position, the conveyor belt 104 of the radial stacker 100 is activated and material is loaded on the infeed end 100A of the radial stacker 100. As the material is off-loaded at the off-load end 100B of the radial stacker 100, the wheels 36 of the wheel assemblies 20 and 50 of the axle assembly 10 can be rotated to move the back or off-load end 100B of the radial stacker 100 which changes the off-load position. In one (1) embodiment, the motors 44 of the first wheel set 34 are activated to move the radial stacker 100. In one (1) embodiment, only the motors 44 in one of the wheel sets 34 are activated while the wheels of the opposite wheel set are allowed to rotate freely. In another embodiment, where the wheel sets 34 have brakes 46, the brakes 46 of the first wheel set 34 located in the direction of the desired movement are engaged. Therefore, to move the radial stacker 100 in a counterclockwise direction, the brakes 46 of the first wheel set 34 on the left side of the radial stacker 100 as viewed from the infeed end 100A of the radial stacker 100 are engaged. Next the second piston cylinder 42 of the first wheel assembly 20 is extended to attempt to move the first wheel set 34 into the unextended position. As the second piston cylinder 42 applies a pushing force on the first end 30A of the connector arm 30, the brakes 46 prevent the wheels 36 from rotating which resists the movement of the first wheel set 34 to the unextended position. The friction between the wheels 36 and the ground surface may also prevent the wheels 36 from moving. Failure of the wheels 36 to move causes the connector arm 30 which is connected to the second piston cylinder 42 to pull the remainder of the radial stacker 100 in a direction toward the braked first wheel set 34. The first wheel set 34 is moved into the unextended position by moving the radial stacker toward the first wheel set 34. When the first wheel set 34 is in the unextended position, the brakes of the second wheel set are engaged and the brakes 46 of the first wheel set 34 are disengaged. The second piston cylinder 42 for the first wheel set 34 is retracted to move the first wheel set 34 back into the extended position. The brakes of the second wheel set prevent the radial stacker 100 from moving as the first wheel set 34 is moved to the extended position. In one (1) embodiment, to reposition the radial stacker 100, the wheel sets 34 are rotated forward so that the axis of rotation C-C of the wheel sets 34 is perpendicular to the longitudinal axis B-B of the radial stacker 100. The position of the axis of rotation of the wheel sets 34 enables the radial stacker 100 to be moved laterally.

It is intended that the foregoing description be only illustrative of the present invention and that the present invention be limited only by the hereinafter appended claims.

I claim:

1. An axle assembly for use with a radial stacker having opposed ends with a conveyor extending between the ends forming a longitudinal axis of the radial stacker, which comprises:
(a) an axle frame having opposed ends and configured to be mounted on the radial stacker; and
(b) a pair of wheel sets pivotably mounted on ends of the axle frame such that each wheel set pivots about one end of the axle frame between a first position with an axis of rotation of the wheel set essentially perpendicular to the longitudinal axis of the radial stacker and a second position with the axis of rotation of the wheel set essentially parallel to the longitudinal axis of the radial stacker and pivots away from and towards the axle frame.

2. The axle assembly of claim 1 wherein when the wheels sets pivot about the end of the axle frame between the first position and the second position, the wheel sets pivot about an essentially vertical axis.

3. The axle assembly of claim 1 wherein when the wheels sets pivot away from and toward the axle frame, the wheel sets pivot about an essentially horizontal axis.

4. The axle assembly of claim 1 wherein the wheel sets are mounted on a second end of connector arms, wherein the connector arms are pivotably connected adjacent the first end to the ends of the axle frame and wherein to pivot the wheel sets away from or toward the axle frame, the first end of the connector arms are moved toward or away from the axle frame in a direction opposite a direction of movement for the wheel sets.

5. The axle assembly of claim 4 wherein a distance between a pivot point of the connector arms and the axle frame and a ground surface is less than a distance between the pivot point and a side of the wheel sets opposite the second end of the connector arms so that when each of the wheel sets is directly below the pivot point, the axle frame is moved upward away from the ground surface.

6. An axle assembly for use with a radial stacker having opposed ends with a conveyor extending between the ends forming a longitudinal axis of the radial stacker, which comprises:
(a) an axle frame having opposed ends forming a longitudinal axis of the axle frame and configured to be mounted on the radial stacker;
(b) a pair of brackets having a first portion and a second portion and pivotably mounted on each of the ends of the axle frame wherein each bracket is able to pivot between a first position with the second portion of the bracket essentially perpendicular to the longitudinal axis of the axle frame and a second position with the second portion of the bracket essentially parallel to the longitudinal axis of the axle frame; and
(c) a pair of wheel sets pivotably mounted on the second portion of each of the brackets wherein each wheel set is able to pivot on the second portion of the bracket between an unextended position with the wheel set adjacent the first portion of the bracket and an extended position with the wheel set spaced apart from the first portion of the bracket.

7. The axle assembly of claim 6 wherein a pair of connector arms having opposed first and second ends are provided, wherein the wheel sets are mounted on the second end of the connector arms and wherein the connector arms are pivotably connected adjacent the first end to the second portion of the brackets.

8. The axle assembly of claim 7 wherein the connector arms are connected to the second portion of the brackets at a pivot point such that the first end of the connector arms extend above the second portion of the brackets and the second end of the connector arms extend below the second portion of the brackets and wherein a distance between the pivot point and the first end of the connector arms is less than a distance between the pivot point and the second end of the connector arms.

9. The axle assembly of claim 7 wherein piston cylinders extend between the first portion of the brackets and the first end of the connector arms to pivot the connector arms to move the wheel sets.

10. The axle assembly of claim 6 wherein piston cylinders extend between the axle frame and the second portion of the brackets to pivot the brackets on the ends of the axle frame.

11. The axle assembly of claim 7 wherein a distance between pivot points of the wheel sets to the brackets and a ground surface is less than a distance between the pivot points and a side of the wheel sets opposite the second end of the connector arms so that when each of the wheel sets is directly below the pivot points, the axle frame is moved upward away from the ground surface.

12. An axle assembly for use with a radial stacker, which comprises:
(a) an axle frame having opposed ends forming a longitudinal axis of the axle frame and configured to be mounted on the radial stacker;
(b) wheel sets, each wheel set having an axis of rotation and movably mounted on the ends of the axle frame;
(c) a means for moving the wheel sets from a first position with the axis of rotation of the wheel sets essentially parallel to the longitudinal axis of the axle frame to a second position with the axis of rotation of the wheel sets essentially perpendicular to the longitudinal axis of the axle frame; and
(d) means for moving the wheel sets toward or away from the axle frame.

13. The axle assembly of claim 12 wherein the means for moving the wheel sets from the first position to the second position is a piston cylinder extending between the axle frame and the wheel sets.

14. The axle assembly of claim 12 wherein the means for moving the wheel sets toward or away from the axle frame is a piston cylinder.

15. The axle assembly of claim 12 wherein the wheel sets have a pair of wheels and wherein the means for moving the wheel sets from the first position to the second position are motors connected to the wheels of the wheel sets which rotate the wheels in opposite directions to move the wheel sets.

16. The axle assembly of claim 12 wherein the means for moving the wheel sets toward or away from the axle frame is a motor connected to the wheel sets for rotating a wheel of the wheel set.

17. A method for moving the wheels of an axle assembly for a radial stacker from a travel mode to an operational mode, the radial stacker having opposed ends forming a longitudinal axis of the radial stacker, the method which comprises the steps of:
(a) providing the axle assembly including an axle frame having opposed ends with a pair of brackets pivotably mounted on each of the ends of the axle frame, and a pair of wheel sets pivotably mounted on each of the brackets;
(b) positioning the pair of wheel sets in the travel mode so that an axis of rotation of each of the wheel sets is essentially perpendicular to the longitudinal axis of the radial stacker;
(c) pivoting the brackets such that the axis of rotation of each of the wheel sets is essentially parallel to the longitudinal axis of the radial stacker;
(d) pivoting each of the wheel sets on the brackets such that the wheel sets are moved from an unextended position adjacent the axle frame outward away from the axle frame to an extended position.

18. The method of claim 17 wherein further in step (d), as the wheel sets move toward the extended position, the wheel sets move directly under a pivot point of the wheel set and the bracket and move the axle frame and the radial stacker upward away from a ground surface and as the wheel sets continue to move toward the extended position, the axle frame and the radial stacker are lowered back toward the ground surface.

19. The method of claim 17 wherein after step (d), the brackets are pivoted back such that the axis of rotation of the wheel sets is at an angle to the longitudinal axis of the radial stacker so that when the wheel sets rotate, the radial stacker moves in an arc about the end of the radial stacker.

20. The method of claim 17 wherein in step (c), the brackets are pivoted such that the axis of rotation of the wheel sets is at an angle to the longitudinal axis of the radial stacker so that when the wheel sets rotate, the radial stacker moves in an arc about the end of the radial stacker.

21. A method for operating a radial stacker having opposed first and second ends forming a longitudinal axis of the radial stacker which comprises the steps of:
(a) providing an axle assembly mounted on the radial stacker having an axle frame with opposed first and second ends with first and second wheel sets pivotably mounted on the first and second ends of the axle frame so that the wheels sets are able to pivot toward and away from the axle frame;
(b) positioning the wheel sets in an extended position away from the axle frame;
(c) engaging a brake of the first wheel set;
(d) pivoting the first wheel set such that the first wheel set is moved from the extended position to an unextended position wherein the brake prevents the first wheel set from moving which moves the radial stacker toward the first wheel set to move the first wheel set from the extended position to the unextended position;
(e) disengaging the brake of the first wheel set;
(f) engaging the brake of the second wheel set; and
(g) pivoting the first wheel set so that the first wheel set moves from the unextended position to the extended position.

22. The method of claim 21 wherein in step (a), the wheel sets are positioned with an axis of rotation of each of the wheel sets at an angle to the longitudinal axis of the radial stacker so that when wheels of the wheel sets rotate, the radial stacker moves in an arc about the first end of the radial stacker.
